(19) United States
(12) Patent Application Publication
(10) Pub. No.: US 2004/0046373 A1
(43) Pub. Date: Mar. 11, 2004

(54) Dual stage airbag inflator

(75) Inventors: Jing-Huei Wang, Taoyuan Hsien (TW); Chi-Wung Wong, Taoyuan Hsien (TW)

Correspondence Address: BACON & THOMAS, PLLC, 625 SLATERS LANE, FOURTH FLOOR, ALEXANDRIA, VA, 22314

(73) Assignee: Chung Shan Institute of Science & Technology, Taoyuan (TW)

(21) Appl. No.: 10/237,017

(22) Filed: Sep. 9, 2002

(51) Int. Cl. B60R 21/26

(52) U.S. Cl. 280/741

(57) ABSTRACT

A dual stage airbag inflator is disclosed to include a housing having an exhaust chamber and multiple peripheral exhaust holes, two chemical chambers disposed within the housing and separately in fluid communication with the exhaust chamber and the exhaust holes, and two igniters respectively mounted in the chemical chambers and adapted for igniting respective gas generant materials in the chemical chambers separately for enabling generated gases to pass out of the first chemical chamber and the second chemical chamber to the outside of the housing via the exhaust chamber and the exhaust holes. There is no interference between different inflation gases that are produced at different times, and a one-way valve flap is used that assures the desired dual stage inflation effect.

### BACKGROUND OF THE INVENTION

1. Field of the Invention

The present invention relates to an airbag inflator and, more particularly, to a dual stage airbag inflator for use in an automobile for deploying the airbag of the automobile with an inflation gas.

2. Description of Related Art

Regular motor vehicle airbags are commonly of one-stage inflation design, i.e., when the actuating signal produced, the exclusive igniter ignites all gas generant material to produce gas. The pressure-time curve obtained from this method has a particular mode that is not variable to fit different application requirements when deployed with the inflation gas, the airbag may cause damage to the driver or passengers having a poor sitting posture. In order to eliminate this problem, dual stage airbag inflators or the so-called “Intelligent airbag inflators” are developed.

U.S. Pat. No. 6,032,979 discloses a dual stage airbag inflator, which can supply airbag inflation gas in an adaptive output. The inflator includes two discrete isolated chambers of gas generant materials and permits to adjust the pressure curve of deploying by controlling the time of igniting of the igniters. However, because the exhaust holes of the second chamber is directly connected to the first chamber, the gas pressure or heat energy produced from the combustion of the gas generant material in the first chamber may enter into the second chamber to ignite the gas generant material in the second chamber accidentally. Therefore, it will be no meaning of using dual stage airbag inflator.

Therefore, it is desirable to provide a dual stage airbag inflator that eliminates the aforesaid drawbacks.

### SUMMARY OF THE INVENTION

It is the main object of the present invention to provide a dual stage airbag inflator, which prevents interference between different inflation gases that are produced at different times, assuring the desired dual stage inflation effect respectively.

It is another object of the present invention to provide a dual stage airbag inflator, which reduces the dynamic energy of combustion particles of the generated inflation gases, improving the filtering performance of the gas filter.

To achieve these and other objects and according to one aspect of the present invention, the dual stage airbag inflator is comprised of a housing, a first igniter, and a second igniter. The housing comprises a plurality of exhaust holes arranged around the periphery thereof, a first chemical chamber mounted inside the housing and comprises a plurality of first gas outlets arranged around the periphery thereof and disposed in communication with an exhaust chamber formed outside the first chemical chamber by the remaining space of the housing and the exhaust chamber and disposed in communication with the exhaust holes, a first inflation gas generant material puts in the first chemical chamber, a second chemical chamber mounted inside the first chemical chamber and comprising at least one second gas outlet disposed in communication with the exhaust chamber, and a second inflation gas generant material puts in the second chemical chamber. A first igniter mounted in the first chemical chamber and adapted for igniting the first inflation gas generant material for producing a first inflation gas for enabling the first inflation gas to pass through the first gas outlets, the exhaust chamber and the exhaust holes to the outside of the housing. A second igniter mounted in the second chemical chamber and adapted for igniting the second inflation gas generant material for producing a second inflation gas for enabling the second inflation gas to pass through the at least one second gas outlet, the exhaust chamber and the exhaust holes to the outside of the housing.

Because the at least one second gas outlet is singly disposed in communication with the exhaust chamber and exhaust holes, therefore the first inflation gas could itself pass through the first gas outlets, the exhaust chamber and the exhaust holes to the outside of the housing directly. It could prevent interference between different inflation gases that are produced at different times and assure the desired dual stage inflation effect respectively.

According to another aspect of the present invention, each second gas outlet is respectively mounted with a normal-close one-way valve flap adapted for isolating the first inflation gas and for enabling only the second inflation gas can pass out of the second chemical chamber through the second gas outlet to the exhaust chamber, exhaust holes and the outside of the housing.

According to still another aspect of the present invention, the housing is comprised of an upper casing and a lower casing, and the exhaust holes are formed in the periphery of either of the upper casing and the lower casing. The upper casing and the lower casing can be fastened together by a screw joint. Alternatively the upper casing and the lower casing can be fastened together by welding, soldering, or any of a variety of conventional fastening means.

According to still another aspect of the present invention, the dual stage airbag inflator further comprises at least one annular flow guide, at least one gas filter and a gasket layer. The at least one annular flow guide mounted in the exhaust chamber to radially separate the exhaust chamber into two or more gas passages that are eccentrically arranged one inside the other and in communication with each other to reduce the dynamic energy of the combustion particles of generated inflation gases and to improve the filtering performance of the gas filter. The at least one gas filter mounted in the exhaust chamber and adapted for filtering solid matter such as combustion particles from the first inflation gas and the second inflation gas. The gasket layer mounted in the exhaust chamber adjacent to an inside wall thereof and adapted for masking the exhaust holes.

Other objects, advantages, and novel features of the invention will become more apparent from the following detailed description when taken in conjunction with the accompanying drawings.

### BRIEF DESCRIPTION OF THE DRAWINGS

FIG. 1 is an exploded view of a dual stage airbag inflator according to the present invention.

FIG. 2 is a sectional view of the present invention, showing the first stage gas deploying action of the dual stage airbag inflator.

FIG. 3 is a sectional view of the present invention, showing the second stage gas deploying action of the dual stage airbag inflator.

FIG. 4 is a pressure-time curve obtained from typical tests in a 60 liters discharge tank according to the present invention.

### DETAILED DESCRIPTION OF THE PREFERRED EMBODIMENTS

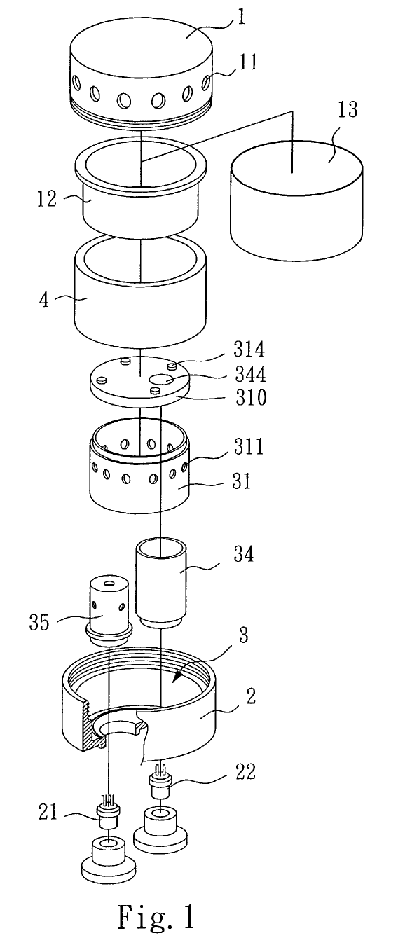

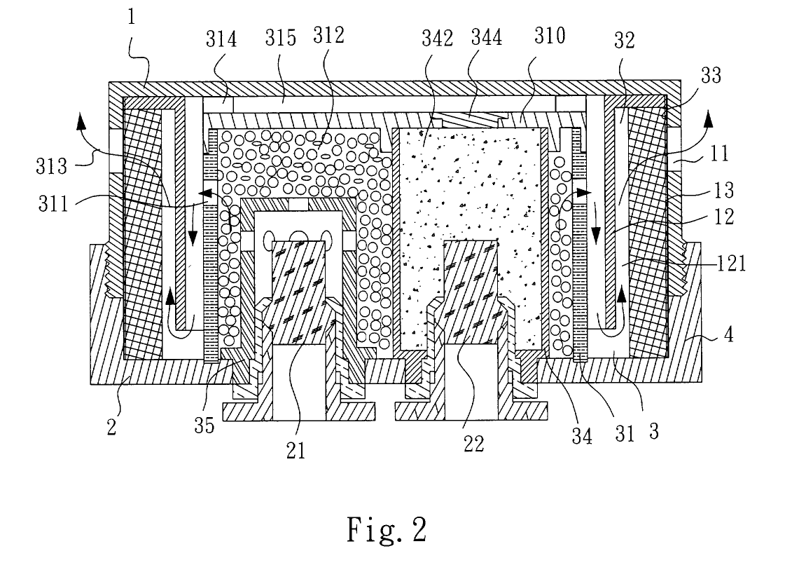

With reference to FIGS. 1 and 2, a dual stage airbag inflator in accordance with the present invention is shown comprising a housing formed of an upper casing 1 and a lower casing 2. The upper casing 1 and the lower casing 2 are fastened together by, for example, a screw joint. The upper casing 1 has a plurality of exhaust holes 11 around the periphery. When the upper casing 1 and the lower casing 2 fastened together, a receiving space 3 is defined within the upper casing 1 and the lower casing 2. A first chemical chamber 31 is disposed inside the receiving space 3. The remaining space outside the chemical chamber 31 within the receiving space 3 forms an exhaust chamber 32, which is in communication with the exhaust holes 11 of the upper casing 1. The top side of the first chemical chamber 31 is sealed with a top cover 310. The first chemical chamber 31 has a plurality of first gas outlets 311 around the periphery in communication with the exhaust chamber 32. A first inflation gas generant material 312 puts in the first chemical chamber 31. A first igniter 21 is installed in the first chemical chamber 31 and adapted for igniting the enhanced material of the enhanced material chamber 35 to combuse the first inflation gas generant material 312 speedily. When ignited, the first inflation gas generant material 312 burns and produces a first inflation gas 313, enabling the produced first inflation gas 313 to pass out of the first gas outlets 311 of the first chemical chamber 31, the exhaust chamber 32 and the exhaust holes 11 into the airbag (not shown) to inflate the airbag instantly.

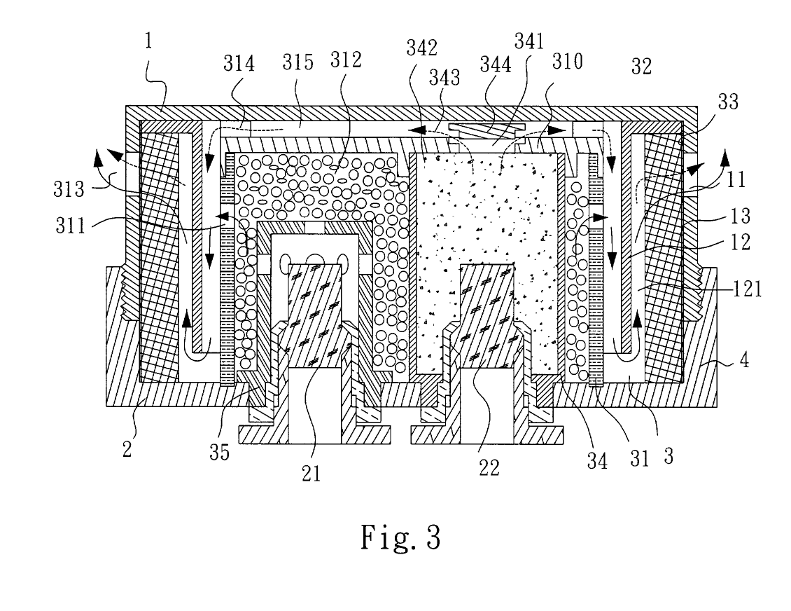

Referring to FIG. 3 and FIG. 1 again, a second chemical chamber 34 is mounted inside the first chemical chamber 31 and sealed with the top cover 310. A second gas outlet 341 is disposed singly on the top cover 310 and in communication with the second chemical chamber 34. Four spacers 314 are protruded from the top sidewall of the top cover 310 to contact with the inside wall of the upper casing 1 to define a gas passage 315 in communication between the second gas outlet 341 and the exhaust chamber 32. A normal-close one-way valve flap 344 is installed in the second gas outlet 341. A second inflation gas generant material 342 puts in the second chemical chamber 34. A second igniter 22 is installed in the second chemical chamber 34 and adapted for igniting the second inflation gas generant material 342. When ignited, the second inflation gas generant material 342 burns and produces a second inflation gas 343, and the normal-close one-way valve flap 344 is opened from the second gas outlet 341 by gas pressure, enabling the produced second inflation gas 343 to pass out of the second chemical chamber 34 through the second gas outlet 341 to the gas passage 315, the exhaust chamber 32, and the exhaust holes 11 to the outside of the housing.

In actual practice, the first igniter 21 is ignited at the first stage to burn the first inflation gas generant material 312 in the first chemical chamber 31, enabling the produced first inflation gas 313 itself to pass through the first gas outlets 311 and the exhaust chamber 32 to the outside of the housing via the exhaust holes 11. Because the second gas outlet 341 is in communication with the exhaust chamber 32 and the exhaust holes 11 independently, the first inflation gas 313 does not pass through the second gas outlet 341 to auto-ignite the second inflation gas generant material 342 in the second chemical chamber 34 accidentally. Furthermore, because the normal-close one-way valve flap 344 normally closes the second gas outlet 341, it prevents the first inflation gas 313 from auto-igniting the second inflation gas generant material 342 accidentally.

A predetermined time delay (for example, 20 ms) after ignition of the first inflation gas generant material 312 enters into the second stage, i.e., the second igniter 22 is started to ignite the second inflation gas generant material 342 in the second chemical chamber 34, thereby causing the second inflation gas generant material 342 to burn and to produce a second inflation gas 343, enabling the produced second inflation gas 343 to pass out of the second chemical chamber 34 through the valve flap 344 of the second gas outlet 341 to the gas passage 315, the exhaust chamber 32, and the exhaust holes 11 to the outside of the housing. The second inflation gas 343 will be mixed with the first inflation gas 313 in the exhaust chamber 32 in this stage.

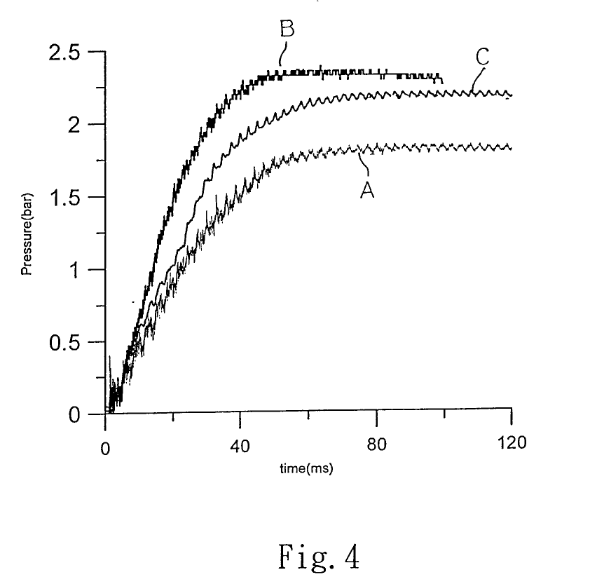

FIG. 4 is a pressure-time curve obtained from typical tests in a 60 liters discharge tank. Curve A is a gas pressure curve obtained from the test where only the first inflation gas generant material is ignited in the first chemical chamber. Curve B is a gas pressure curve obtained from the test where the first inflation gas generant material and the second inflation gas generant material are respectively ignited in the first chemical chamber and the second chemical chamber at the same time (the time delay is zero). Curve C is a gas pressure curve obtained from the test where the first inflation gas generant material and the second inflation gas generant material are respectively ignited in the first chemical chamber and the second chemical chamber at different times (for example, the second inflation gas generant material is ignited at 20 ms after the ignition of the first inflation gas generant material). By controlling the delay time of dual stage of igniting the gas generant materials in different chemical chambers flexibly, it could protect the driver or passengers having a poor sitting posture and assure the desired dual stage inflation effect.

Referring to FIG. 3, an annular flow guide 12 is mounted in the exhaust chamber 32 to radially separate the exhaust chamber into two gas passages 121 that are eccentrically arranged one inside the other and in communication with each other. The gas passages 121 form a maze of flow path. When the first inflation gas 313 and the second inflation gas 343 produced, the flow guide 12 guides the flow of gas to go by a detour, thereby causing the dynamic energy of combustion particles of the gases 313,343 to be reduced. A gas filter 4 is mounted in the exhaust chamber 32, and adapted for filtering solid matter such as combustion particles from the first inflation gas 313 and the second inflation gas 343. Reducing the dynamic energy of combustion particles of the gases passing through the gas filter 4 relatively increase the filtering performance of the gas filter 4. There is also provided an annular gasket layer 13 mounted in the exhaust chamber 32 adjacent the housing's inside wall 33 and adapted for making the exhaust holes 11 to isolate outside moisture from passing to the chemical chambers 31,34.

According to this embodiment, the annular gasket layer 13 is made of aluminum foil. Other equivalent sealing material may be used for making the annular gasket layer 13 to isolate outside moisture from passing to the chemical chambers 31,34.

The aforesaid members may be welded or soldered together, or sealed with On-rings or other sealing materials. The mechanical mounting and airtight sealing arrangement can easily be achieved by conventional techniques.

Although the present invention has been explained in relation to its preferred embodiments, it is to be understood that many other possible modifications and variations can be made without departing from the spirit and scope of the invention as hereinafter claimed.

What is claimed is:

1. A dual stage airbag inflator comprising:
a housing, said housing comprising a plurality of exhaust holes arranged around the periphery thereof, a first chemical chamber mounted inside said housing and comprising a plurality of first gas outlets arranged around the periphery thereof and disposed in communication with an exhaust chamber formed outside said first chemical chamber by the remaining space of said housing and said exhaust chamber and disposed in communication with said exhaust holes, a first inflation gas generant material puts in said first chemical chamber, a second chemical chamber mounted inside said first chemical chamber and comprising at least one second gas outlet disposed in communication with said exhaust chamber, and a second inflation gas generant material puts in said second chemical chamber;
a first igniter mounted in said first chemical chamber and adapted for igniting said first inflation gas generant material for producing a first inflation gas for enabling said first inflation gas to pass through said first gas outlets, said exhaust chamber and said exhaust holes to the outside of said housing; and
a second igniter mounted in said second chemical chamber and adapted for igniting said second inflation gas generant material for producing a second inflation gas for enabling said second inflation gas to pass through said at least one second gas outlet, said exhaust chamber and said exhaust holes to the outside of said housing.

2. The dual stage airbag inflator as claimed in claim 1, wherein said at least one second gas outlet each is mounted with a normal-close one-way valve flap adapted for enabling said second inflation gas to pass out of said second chemical chamber to the outside of said housing through said exhaust chamber and said exhaust holes.

3. The dual stage airbag inflator as claimed in claim 1, wherein said housing is comprised of an upper casing and a lower casing, and said exhaust holes are formed in the periphery of either of said upper casing and said lower casing.

4. The dual stage airbag inflator as claimed in claim 3, wherein said upper casing and said lower casing are fastened together by a screw joint.

5. The dual stage airbag inflator as claimed in claim 1, further comprising an annular flow guide mounted in said exhaust chamber to radially separate said exhaust chamber into two gas passages that are eccentrically arranged one inside the other and in communication with each other.

6. The dual stage airbag inflator as claimed in claim 1 further comprising a gas filter mounted in said exhaust chamber and adapted for filtering solid matter from said first inflation gas and/or said second inflation gas.

7. The dual stage airbag inflator as claimed in claim 1, wherein said housing comprises a gasket layer mounted in said exhaust chamber adjacent to an inside wall thereof and adapted for masking said exhaust holes.

8. The dual stage airbag inflator as claimed in claim 7, wherein said gasket layer is formed of an annular aluminum foil.
